(19) United States
(12) Patent Application Publication
(10) Pub. No.: US 2003/0150427 A1
(43) Pub. Date: Aug. 14, 2003

(54) Fuel injection valve

(76) Inventor: Uwe Liskow, Asperg (DE)

Correspondence Address: KENYON & KENYON, ONE BROADWAY, NEW YORK, NY, 10004, US

(21) Appl. No.: 10/275,052

(22) PCT Filed: Feb. 27, 2002
(86) PCT No.: PCT/DE02/00692

(30) Foreign Application Priority Data
Feb. 28, 2001 (DE) 101 09 611.9

(51) Int. Cl. F02M 55/02

(52) U.S. Cl. 123/470; 123/468

(57) ABSTRACT

A fuel injector (1) for the direct injection of fuel, especially into the combustion chamber of a mixture-compressing internal combustion engine having external ignition, is located in a cylinder head (2) of the internal combustion engine in a receiving bore (8) of the cylinder head (2), and includes a nozzle body (10) and a sealing ring (14) which seals the fuel injector (1) from the cylinder head (2) of the internal combustion engine. At an end (12) on the discharge side of the fuel injector (1), an at least partially spherical body (13) is formed which abuts at least partially against a wall (9) of the receiving bore (8), a groove (15) being circumferentially formed on the body (13) in which the sealing ring (14) is positioned.

### BACKGROUND INFORMATION

The present invention is directed to a fuel injector according to the species defined in claim 1 or claim 11.

German laid open print DE 197 35 665 A1 describes a fuel injection system which has a compensating element made of a supporting body having a dome-shaped supporting surface. This compensating element supports a fuel injector in a receiving bore of a cylinder head. In the ring gap between the receiving bore and fuel injector, a sealing ring which seals the ring gap from the combustion chamber, is located in a groove in the fuel injector. Since the fuel injector rests on the spherically shaped calotte surface by way of a supporting surface, the fuel injector can be mounted at an angle that deviates from the axis of the receiving bore by up to a certain amount, and can be pressed firmly into the receiving bore using appropriate means, e.g., a clamping shoe. This allows a simple adaptation to be made to the fuel supply lines. As a result, tolerances can be compensated for in the manufacture and installation of the fuel injectors.

However, disadvantageous in the fuel-injection system known from DE 197 35 665 A1 is that the known embodiment, while it does allow a larger tolerance angle, only worsens the problem of sealing the ring gap between receiving bore and the fuel injector. This is because in the case of a larger tilting angle, the seal is produced only by the elasticity of the sealing ring, in that it has a large cross-sectional area and elasticity, and must provide sealing action even in the case of substantially uneven squeezing.

### SUMMARY OF THE INVENTION

In contrast, the fuel injector according to the present invention, having the characterizing features of claim 1, has the advantage that a sealing effect of the sealing ring is ensured even at large tilting angles, due to the sphere-segment shaped design of the body formed at the discharge-side end of the nozzle body, since the spherical body abuts against a calotte formed at a wall of the receiving bore by way of a large surface area.

Furthermore, the spring inserted between the fuel injector and the fuel distributor line, as recited in claim 11, ensures that leaks at a connection piece of the fuel distributor line are avoided and the axial displacement of the fuel injector is held in check.

Advantageous further refinements and improvements of the fuel injector mentioned in claim 1 are rendered possible by the measures specified in the dependent claims.

It is especially advantageous that the sealing ring, depending on the form of the calotte, may be positioned at the equator or on the discharge side of the equator of the spherical body.

The formation of a recess and the slip-fitting of the spherical body onto the nozzle body are also advantageous since the conventional fuel injector may be inserted into the spherical body without modification, the-original seal assuming the sealing between the nozzle body and the slip-fitted spherical body.

Preferably, the calotte may be replaced by a conical beveling of the wall of the receiving bore, which facilitates the machining of the cylinder head. The uncomplicated machining of the cylinder head and the sealing effect of the calotte may also be combined by using an insert at which the calotte is formed, the insert being able to be pressed into the receiving bore. As a result, the sealing ring may even be dispensed with altogether, due to the compression effect.

### BRIEF DESCRIPTION OF THE DRAWING

Exemplary embodiments of the present invention are shown in a simplified version in the drawing, and are elucidated in greater detail in the following description. The figures show:

FIG. 1 schematic, part-sectional view of a first exemplary embodiment of a fuel injector according to the present invention in a cylinder head of an internal combustion engine;

FIG. 2A a schematic cut-away portion of the fuel injector constructed according to the present invention as shown in FIG. 1, in the area IIA in FIG. 1;

FIG. 2B a schematic cut-away portion of a second exemplary embodiment of a fuel injector constructed according to the present invention, in the same area as FIG. 2A;

FIG. 3A a schematic cut-away portion of a third exemplary embodiment of a fuel injector constructed according to the present invention;

FIG. 3B a schematic cut-away section of a fourth exemplary embodiment of a fuel injector constructed according to the present invention;

FIG. 4 a schematic cut-away section of a fifth exemplary embodiment of a fuel injector constructed according to the present invention;

FIG. 5 a schematic section from a sixth exemplary embodiment of a fuel injector constructed according to the present invention; and

FIG. 6 a schematic, part-sectional view of a seventh exemplary embodiment of a fuel injector according to the present invention.

### DESCRIPTION OF THE EXEMPLARY EMBODIMENTS

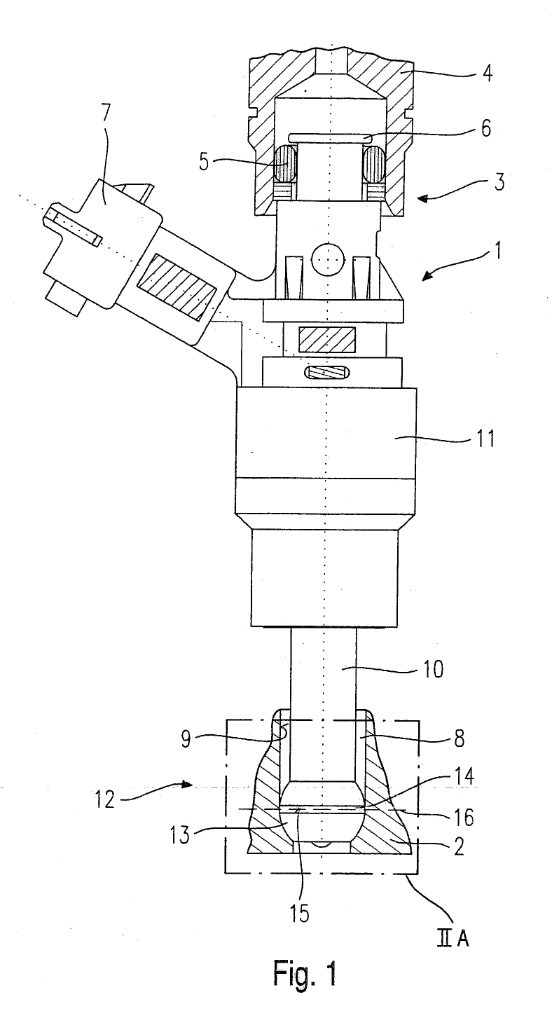

FIG. 1 shows a schematic partial section through an exemplary embodiment of a fuel injector, designed in accordance with according to the present invention, in a receiving bore of a cylinder head of an internal combustion engine having external ignition.

In this case, a fuel injector 1 is designed in the form of a directly injecting fuel injector 1 and installed in a cylinder head 2 of an internal combustion engine. At an end 3 on the inflow-side, fuel injector 1 is provided with a plug connection to a fuel-distributor line 4, which is sealed by a seal 5 between fuel distributor line 4 and a supply connection 6 of fuel injector 1. Fuel injector 1 is provided with an electrical connection 7 for the electrical contacting to actuate fuel injector 1.

Fuel injector 1 is positioned in a receiving bore 8 of cylinder head 2 and has a nozzle body 10 and a valve housing 11. Valve housing 11 may supportively rest against a wall 9 of receiving bore 8. According to the present invention, at an end 12 on the discharge side, nozzle body 10 has a spherical body 13 which seals cylinder head 2 from the combustion chamber (not further shown) of the internal combustion engine using a sealing ring 14. Sealing ring 14 is preferably positioned in a groove 15, which is circumferentially formed at spherical body 13.

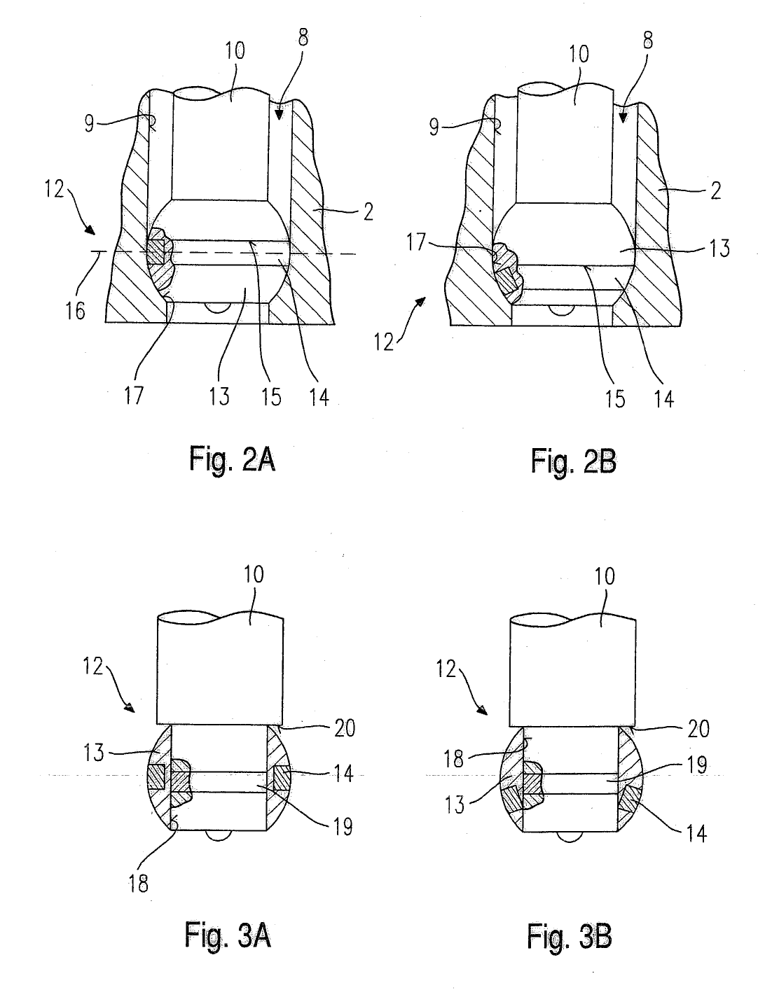

In the first exemplary embodiment, terminal spherical body 13 is integrally formed with nozzle body 10. A detailed description of the first exemplary embodiment may be inferred from the description relating to FIG. 2A.

FIG. 2A shows a schematic cut-away portion, in region IIA in FIG. 1, of the fuel injector constructed according to the present invention as shown in FIG. 1. A partial section is shown in a cut-away view to clarify the measures of the present invention. Equivalent components have been provided with corresponding reference numerals in all figures.

As already explained in FIG. 1, spherical body 13, which accommodates sealing ring 14, is formed on the discharge side of end 12 of fuel injector 1. In the present exemplary embodiment, sealing ring 14 is positioned at an equator 16 of spherical body 13. Preferred materials for the manufacture of sealing ring 14 are, for instance, Teflon® or copper, which are highly flexible and, therefore, easily adapted to the position of fuel injector 1 in receiving bore 8.

Receiving bore 8 of cylinder head 2 has a calotte 17 in which spherical body 13 abuts against wall 9 of receiving bore 8. Given a straight alignment of fuel injector 1, which is mounted in receiving bore 8 without displacement, sealing ring 14 abuts fully against calotte 17.

Should fuel injector 1 be displaced in receiving bore 8 of cylinder head 2, for instance, due to manufacturing tolerances of individual components or uneven warming of fuel injector 1 during operation, fuel injector 1 tilts relative to cylinder head 2, so that the position of sealing ring 14 at spherical body 13 relative to calotte 17 changes as well. However, because of the plasticity of the material of sealing ring 14, the displacement is compensated for in such a way that the sealing effect is completely maintained.

FIG. 2B shows schematic cut-away portion of a second exemplary embodiment of a fuel injector designed in accordance with the present invention, in the same area as FIG. 2A.

The design of the second embodiment is similar to that of the exemplary embodiments described in FIGS. 1 and 2A, sealing ring 14 now being positioned downstream from equator 16. Preferably, sealing ring is again inserted into a circumferential groove 15 and, given a fuel injector 1 that is installed in a straight fashion, abuts directly against the bearing surface formed by calotte 17. Consequently, it is possible to compensate even for displacements of greater magnitude. In order to offer an alternative volume for the material of sealing ring 14 when compensating for displacements, groove 15 must have an undercut volume, for instance, since sealing ring 14 is deformed in such a way that it is flush with spherical body 13. A groove 15 having a slightly larger diameter than sealing ring 14 likewise presents itself for providing an alternative volume.

With respect to the placement of sealing rings 14, the exemplary embodiments shown in FIGS. 3A and 3B are equivalent to those represented in the exemplary embodiments shown in FIGS. 2A and 2B. The third and fourth exemplary embodiment have in common that spherical body 13 at end 12 on the downstream side of nozzle body 10 is not integrally formed with nozzle body 10. Instead, spherical body 13 has an inner recess 18 as a through opening into which downstream end 12 of nozzle body 10 is insertable. In this case, an additional sealing ring 19 must be placed between nozzle body 10 and spherical body 13 for sealing, so as to maintain the sealing effect between combustion chamber and cylinder head 2. The particular advantage of this system is that a conventional placement of sealing ring 19 at nozzle body 10 need not be changed, but that spherical body 13 is merely slipped onto end 12 of nozzle body 10. The sole requirement for nozzle body 10 is a contact flange 20 on which spherical body 13 may be supported.

Spherical body 13 may be mounted on end 12 of nozzle body 10 either by merely pressing it onto sealing ring 19, or by additionally securing it by a spot weld. It is advantageous in all of the above described exemplary embodiments that the spherical form of body 13 need only be produced in those areas that come into consideration as possible contact surfaces, depending on the tilting angle of fuel injector 1. Since this angle is limited, for instance, by the geometry of receiving bore 8 on the inflow side, it is not required that body 13 has an allover spherical design.

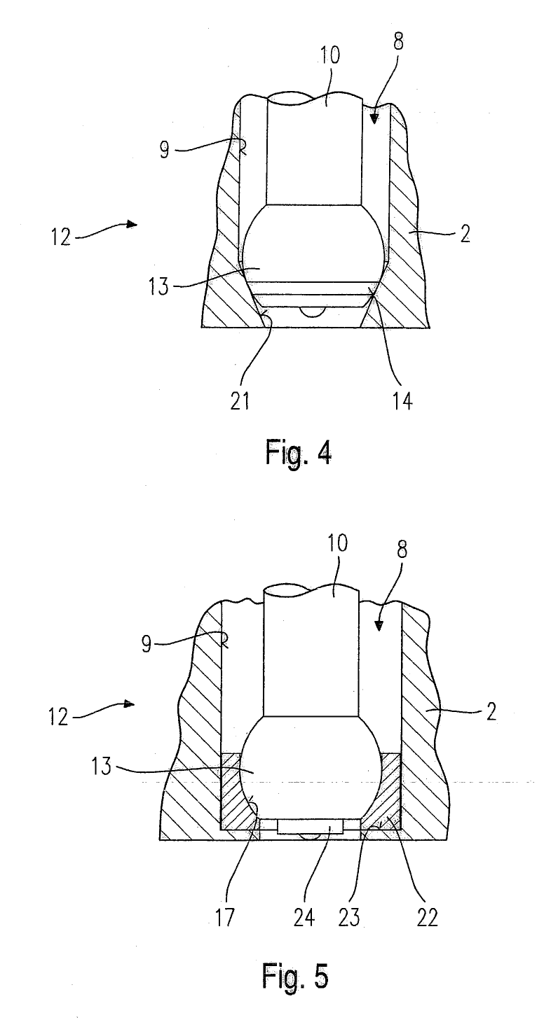

FIG. 4 shows a schematic cut-away section from a fifth exemplary embodiment of a fuel injector constructed according to the present invention.

In contrast to the previous exemplary embodiments, receiving bore 8 of cylinder head 2 is not provided with a calotte 17 in the region of downstream end 12 of nozzle body 10 of fuel injector 1, but merely a conical bevel 21. Since this arrangement only provides a circumferential linear-shaped sealing surface, sealing ring should be positioned, as in the exemplary embodiment described in FIG. 2B, on the discharge side of equator 16 so as to achieve a reliable sealing effect. It is advantageous in this exemplary embodiment that no special demands are made on the form of bevel 21; thus, the working of receiving bore 8 is correspondingly simple and inexpensive.

FIG. 5 shows a schematic cut-away section from a sixth exemplary embodiment of a fuel injector 1 constructed according to the present invention.

The exemplary embodiments described in FIGS. 1 to 3, due to the form of calotte 17 and the large contact surface resulting therefrom, provide a high degree of sealing, even without sealing ring 14. This is utilized in the exemplary embodiment shown in FIG. 5 insofar as calotte 17 is formed on an annular insert 22 that is pressed into receiving bore 8, which has a shoulder 23. In this way, a straining of annular insert 22 may further contribute to the sealing effect, so that it is possible to dispense with a separate sealing ring 14 and a groove 15 as well.

In order to reduce the dead volume between the sealing region and the combustion chamber, fuel injector 1 shown in FIG. 5 is additionally provided with an elongation 24. This further measure may likewise be applied to the afore-described exemplary embodiments and is especially useful for reducing the dead volume in the fuel injectors 1 shown in FIGS. 2A and 2B and 4.

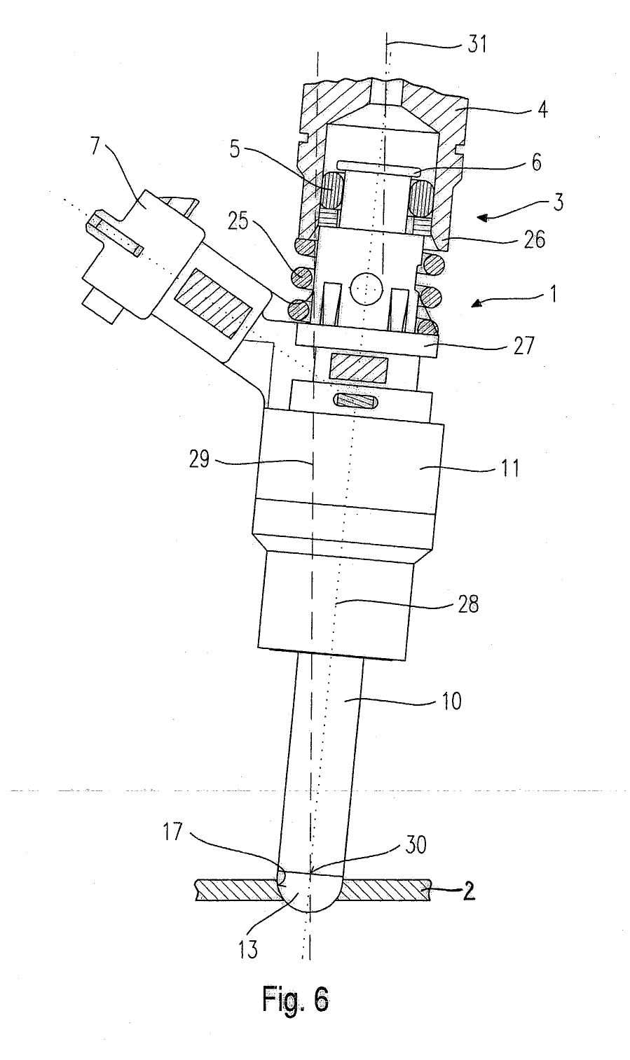

FIG. 6 shows a schematic, part-sectional view of a seventh exemplary embodiment of a fuel injector 1 according to the present invention, in an overall view.

While the measures intended to compensate for displacements and misalignments of fuel injector 1 in receiving bore 8 of cylinder head 2 are limited to end 12 of nozzle body 10 of fuel injector 1, the present exemplary embodiment also provides a device for compensating offsets resulting from tilting or displacements of fuel injector 1 relative to fuel supply line 4.

In particular, this is a spring 25, which is clamped between a connecting piece 26 of fuel-distributor line 4 and a shoulder 27 of fuel injector 1.

If fuel injector 1, for example due to manufacturing tolerances, is mounted in receiving bore 8 at a tilt, this will result in a radial displacement relative to connecting piece 26 of fuel-distributor line 4, which at times may assume considerable values. In FIG. 6, the possible displacements are marked using different axes. In this context, the dotted line marks a longitudinal axis 28 of fuel injector 1. As shown in FIG. 6, this may be tilted at an angle of 5°, for instance, relative to a general axis of symmetry 29 that is perpendicular to cylinder head 2, merely sketched in FIG. 6, and which bisects longitudinal axis 28 of fuel injector 1 in an imaginary center point 30 of spherical body 13. This, in turn, results in a certain angular deviation of connecting piece 26 of fuel-distributor line 4 relative to supply piece 6 of fuel injector 1. Spring 25, according to the present invention, in connection with a spherical body 13, configured in accordance with the above-described exemplary embodiments, at the downstream end 12 of fuel injector 1 is able to counteract the angular deviation to a certain degree. In FIG. 6, longitudinal axis 31 of connecting piece 26 of fuel-distributor line 4 is represented by a dash-dot line for better orientation.

The present invention is not limited to the exemplary embodiments shown and is also applicable to fuel injectors 1 for injection into the combustion chamber of an internal combustion engine having self-ignition.

What is claimed is:

1. A fuel injector (1) for the direct injection of fuel, especially into the combustion chamber of a mixture-compressing internal combustion engine having external ignition, the fuel injector being positioned in a cylinder head (2) of the internal combustion engine in a receiving bore (8) of the cylinder head (2), and comprising a nozzle body (10) and a sealing ring (14) which seals the fuel injector (1) from the cylinder head (2) of the internal combustion engine, wherein, at a downstream side of end (12) of the fuel injector (1), an at least partially spherical body (13) is formed which at least partially abuts against a wall (9) of the receiving bore (8), at the body (13) a receptacle (15) being circumferentially formed in which the sealing ring (14) is placed.

2. The fuel injector as recited in claim 1,
wherein the wall (9) forms a calotte (17) in the region of the at least partially spherical body (13).

3. The fuel injector as recited in claim 1 or 2,
wherein the receptacle is designed as circumferential groove (15), and the groove (15) is formed at an equator (16) of the at least partially spherical body (13).

4. The fuel injector as recited in claim 1 or 2,
wherein the receptacle is designed as circumferential groove (15), and the groove (15) is formed at the downstream side of the equator (16) of the at least partially spherical body (13).

5. The fuel injector as recited in one of claims 1 through 4,
wherein the body (13) is integrally formed with the nozzle body (10) of the fuel injector (1).

6. The fuel injector as recited in one of claims 1 through 4,
wherein the at least partially spherical body (13) is provided with an inner recess (18) and is able to be slipped onto the nozzle body (10).

7. The fuel injector as recited in claim 6,
wherein, by way of a seal (19), the nozzle body (10) seals against the at least partially spherical body (13) slipped onto the nozzle body (10).

8. The fuel injector as recited in claim 1,
wherein the wall (8) of the receiving bore (9) has a conical bevel (21) against which the sealing ring (14) abuts.

9. The fuel injector as recited in claim 1,
wherein the at least partially spherical body (13) abuts against an insert (22) on which a calotte (17) is formed and which is inserted into the receiving bore (8) of the cylinder head (2).

10. The fuel injector as recited in claim 9,
wherein the insert (22) rests on a shoulder (23) of the receiving bore (8) of the cylinder head (2).

11. A fuel injector (1) for the direct injection of fuel, especially into the combustion chamber of a mixture-compressing internal combustion engine having external ignition, the fuel injector being located in a cylinder head (2) of the internal combustion engine, in a receiving bore (8) of the cylinder head (2), and having a nozzle body (10) and a sealing ring (14) which seals the fuel injector (1) from the cylinder head (2) of the internal combustion engine,
wherein a spring (25) is clamped between a fuel-distributor line (4) and the fuel injector (1) and enables the fuel injector (1) to be elastically aligned in its position relative to a connecting piece (26) of the fuel-distributor line (4).

12. The fuel injector as recited in claim 11,
wherein the spring (25) is braced, by way of an upstream-side end, against a connecting piece (26) of the fuel-distributor line (4).

13. The fuel injector as recited in claim 11,
wherein the spring (25) is braced against a shoulder (27) of the fuel injector (1) at downstream-side end.

14. The fuel injector as recited in one of claims 11 through 13,
wherein, at a downstream-side end (12) of the fuel injector (1), an at least partially spherical body (13) is formed which at least partially abuts against a wall (9) of the receiving bore (8), a receptacle (15) being circumferentially formed at the body (13) in which the sealing ring (14) is positioned.
